(19) United States
(12) Patent Application Publication
(10) Pub. No.: US 2010/0078104 A1
(43) Pub. Date: Apr. 1, 2010

(54) Siloxane-based lubricating compositions that release no hydrogen

(76) Inventors: Stefan Breunig, Villette de Vienne (FR); Nadia Martin, Lyon (FR)

Correspondence Address: BUCHANAN, INGERSOLL & ROONEY PC, POST OFFICE BOX 1404, ALEXANDRIA, VA, 22313-1404, US

(21) Appl. No.: 12/308,691

(22) PCT Filed: Jun. 15, 2007
(86) PCT No.: PCT/EP2007/055962

§ 371 Date: Oct. 1, 2009

(30) Foreign Application Priority Data
Jun. 20, 2006 (FR) 0605465

(51) Int. Cl. B60C 5/00; C10M 107/50

(52) U.S. Cl. 152/155; 508/208; 508/107

(57) ABSTRACT

Lubricating compositions, in the form of oil-in-water emulsions, are based on a siloxane and do not release hydrogen and are particularly suited for the lubrication of internal surfaces of uncured or unvulcanized envelopes useful for the manufacture of rubber pneumatic or semi-pneumatic tires for vehicles, as well as for vulcanization bladders useful for the shaping and vulcanizing of pneumatic or semi-pneumatic tires.

The invention relates to a lubricating composition which is particularly appropriate for the lubrication of:
internal surfaces of green or uncured envelopes intended for the manufacture of pneumatic or semipneumatic rubber tires for vehicles, and
curing bladders used in the shaping and curing of pneumatic or semipneumatic tires.

The invention also relates to the curing bladders coated with a lubricating composition according to the invention, and to the pneumatic or semipneumatic tires coated with said lubricating composition.

According to two other of its aspects, the invention relates to the use of said lubricating compositions for lubricating curing bladders and internal surfaces of green or uncured envelopes intended for the manufacture of pneumatic or semipneumatic rubber tires for vehicles.

Rubber tires for vehicles are commonly manufactured by molding and curing a green, or uncured and unshaped, envelope in a molding press, in which the green envelope is pressed toward the outside against the surface of a mold by means of a bladder which is expandable by an internal fluid. By this method, the green envelope is shaped against the external surface of the mold, which defines the design of the tire tread of the envelope and the configuration of the sidewalls. By heating, the envelope is cured. In general, the bladder is expanded by the internal pressure provided by a fluid such as a hot gas, hot water and/or steam, which also participates in the transfer of heat for curing. The envelope is then left to cool a little in the mold, this cooling being sometimes promoted by the introduction of cold or cooler water into the bladder. The mold is then opened, the bladder is deflated by releasing the pressure of the internal fluid, and the envelope is removed from the envelope mold. This use of bladders for curing envelopes is well known in the art.

It is accepted that a significant relative movement occurs between the outer contact surface of the bladder and the internal surface of the envelope during the bladder expansion phase before complete curing of the envelope. Similarly, there is also a considerable relative movement between the outer contact surface of the bladder and the cured internal surface of the envelope, after the envelope has been molded and cured, during the deflation and extraction of the bladder from the tire.

If adequate lubrication is not provided between the bladder and the internal surface of the envelope, the bladder generally has a tendency to warp, which causes deformation of the envelope in the mold and also excessive tarnishing and wear of the surface of the bladder itself. The surface of the bladder also tends to stick to the internal surface of the envelope, after the curing of the envelope and during the part of the envelope curing cycle during which the bladder is deflated. Moreover, air bubbles may be trapped between the surfaces of the bladder and the envelope, and may promote the appearance of curing defects in the envelopes, resulting from inadequate heat transfer.

For this reason, the outer surface of the bladder or the internal surface of the green or uncured envelope is coated with an appropriate lubricant, sometimes referred to as a “lining cement”.

Numerous lubricant compositions have been proposed for this purpose in the art.

Known in particular are the lubricating compositions described in FR 2 494 294, which contain, as principal constituents, a reactive polydimethylsiloxane preferably having terminal hydroxyl groups, a crosslinking agent preferably comprising Si—H functions, and, optionally, a polycondensation catalyst. Examples of Si—H-functional crosslinking agents are methylhydrosilane, dimethylhydrosilane, polymethylhydrosilane, and polymethylhydrosiloxane. The disadvantage of this type of lubricating compositions is their instability on storage. Indeed, creaming of the emulsion is observed, following on from the release of hydrogen during the transport and keeping of the lubricating composition. The release of hydrogen, which is responsible for the instability of the prior-art compositions, results essentially from the decomposition of the Si—H-functional constituents.

The preparation of lubricating compositions from constituents which do not contain the Si—H function, and which nevertheless have excellent durability, lubrication, and elasticity properties, is therefore highly desirable.

The compositions forming the subject of patent application EP 635 559 are siloxane-based lubricating compositions which partly meet these requirements. These compositions are, in particular, more stable, in that they do not release hydrogen during storage.

These compositions, which take the form of emulsions, comprise as essential constituents a nonreactive polydimethylsiloxane, a reactive polydimethylsiloxane, preferably with a hydroxyl or alkoxy terminus, and a crosslinking agent. However, their durability is insufficient for practical use in the production of pneumatic or semipneumatic tires.

As another example of the prior art, mention may be made of the international application WO-A-03/087227, which describes a composition in the form of a silicone oil-in-water emulsion, based on siloxane, which does not release hydrogen, and which is useful in the molding/demolding of tires, comprising:
(a) optionally at least one nonreactive linear polyorganosiloxane oil with lubricating properties, having a dynamic viscosity of the order of 5·10⁻² to 30·10² Pa·s at 25° C.;

(a′) at least one reactive linear polyorganosiloxane oil containing at least two OH groups per molecule and having a dynamic viscosity of from 5·10⁻² to 200 000, more particularly from 5·10⁻² to 150 000, preferably from 5·10⁻² to 3000 Pa·s at 25° C.;

(b) at least one polyorganosiloxane resin which carries condensable hydroxyl substituents and contains at least two siloxy units;

(c) at least one crosslinker which is soluble in the silicone phase and comprises at least two functions capable of reacting with the polyorganosiloxane resin (b);

(d) at least one condensation catalyst capable of catalyzing the reaction of constituent (b) with constituent (c);

(e) at least one surfactant; and

(f) water,

the constituent (a)/constituent (a′) weight ratio being situated in the range from 0 to 10.

This composition, when it is crosslinked on the bladder, is able to play the role either of a lubricating composition or of an adhesion primer which has sufficient lubricating properties to render the application of a supplementary lubricating composition unnecessary.

A similar approach was described in international application WO-A-01/40417, which also uses a tin-based catalytic compound.

However, although advantageous for the lubrication aspect, this type of composition has the drawback of using metallic condensation catalysts, based for example on tin, which are expensive and whose presence is undesirable for reasons of toxicity. Moreover, these emulsions have the drawback of a loss of activity after prolonged storage, a fact which contributes to an acknowledged fall in the number of moldings/demoldings in the mold pressing/bladder release cycles employed in the manufacture of the tires.

Furthermore, the tire industry is continually in search of lubricating compositions that allow both of the following properties to be obtained:
high durability in direct application to a bladder (useful for the manufacture of heavy-vehicle tires, an operation characterized by ease of access to the bladder),
high durability in transfer of the envelope to a bladder (useful for the manufacture of lightweight-vehicle tires, an operation characterized by difficulty of access to the bladder, which is the reason for treatment of the green tire and then transferred to the bladder), and
good sliding properties (Kd less than 0.45).

The present invention provides an improved lubricating composition which does not release hydrogen, does not contain metal condensation catalyst, and, furthermore, exhibits excellent sliding and durability features, thereby making them ideally suited to the lubrication of the bladders which are used during the curing of the pneumatic and semipneumatic tires of heavy and lightweight vehicles.

The lubricating composition of the invention is a siloxane-based lubricating composition, in the form of an oil-in-water emulsion, which does not release hydrogen, comprising:

(a) at least one nonreactive polydiorganosiloxane oil (A) having lubricating properties, exhibiting a dynamic viscosity of the order of 20 to 100 000 mPa·s at 25° C.;

(b) at least one reactive linear polydiorganosiloxane oil (B) having per molecule at least two OH groups, said polydiorganosiloxane exhibiting a dynamic viscosity at 25° C. of between 50 and 50×10⁶ mPa·s,

(c) optionally at least one polyorganosiloxane resin (C) which before emulsification carries condensable hydroxyl substituents and which before emulsification contains at least two different siloxy units selected from those of formula)(R⁰)₃SiO_{1/2} (M); (R⁰)₂SiO_{2/2} (D); R⁰SiO_{3/2} (T), and SiO_{4/2} (Q), at least one of these units being a T or Q unit, R⁰ in the formulae representing a monovalent organic substituent, the average number of organic radicals R⁰ per molecule for one silicon atom being between 1 and 2; and said resin having a weight content of hydroxyl or alkoxy substituents of between 0.1% and 10% by weight and, preferably, between 0.2% and 5% by weight,

(d) at least one crosslinker (D) which is soluble in the silicone phase,

(e) at least one water-soluble crosslinker (E), whose formula, in its monomeric form, is:

(R²)(R¹)N—R^{a}—Si(OH)₃

in which R^{a} represents a C₁-C₂₀ alkylene group, with R¹ and R² representing independently a hydrogen atom or a C₁-C₆ alkyl group, said crosslinker being able to take an oligomeric form by condensation of one or more silanol functions,

(f) at least one surfactant (F),

(g) water (K),

(h) at least one film-forming polymer (G),

(i) optionally at least one thickener (H),

(j) optionally at least one wetting agent (I), and

(k) optionally at least one additive (J),
with the following further conditions:

(1) the amounts of surfactants and water are sufficient to give an oil-in-water emulsion, and

(2) said lubricating composition contains no metallic condensation catalyst.

The principal advantage of the composition according to the invention is that it allows a demolding and lubricating film to be obtained, either by transfer or by direct application, which retains its performance over multiple demoldings, in spite of the absence of SiH functions.

The constituents (A), (B), (C), (D), (E), (F), (G), (H), (I), (J), and (K) of the emulsion are defined by reference to their initial chemical structure, in other words the structure which characterizes them prior to emulsification. As soon as they are in an aqueous medium, their structure is liable to be modified greatly in the wake of hydrolysis and condensation reactions.

In the context of the invention, the term “nonreactive” refers to an oil which, under the conditions of emulsification, preparation of the lubricating composition, and use, does not react chemically with any of the constituents of the composition.

Preferred constituents (A) include linear polydiorganosiloxanes with a repeating unit of formula V¹V²SiO_{2/2}, which is terminated at its chain ends by units V³V⁴V⁵SiO_{1/2}, where V¹, V², V³, V⁴, and V⁵, which are identical or different, represent a monovalent organic group selected from alkyl, alkenyl, aryl, cycloalkyl, cycloalkenyl, aralkyl or alkaryl.

In these oils, alkyl denotes a preferably C₁-C₁₈, linear or branched, saturated hydrocarbon group (such as methyl, ethyl, and propyl); alkenyl denotes a preferably C₂-C₈ linear or branched hydrocarbon group containing one or more ethylenic unsaturations (such as vinyl, allyl, and butadienyl); aryl denotes a preferably C₆-C₁₀ monocyclic or polycyclic aromatic hydrocarbon group (such as phenyl or naphthyl); cycloalkyl denotes a preferably C₃-C₈ saturated, monocyclic or polycyclic, carbocyclic group (such as cyclohexyl); cycloalkenyl denotes a cycloalkyl group having one or more unsaturations, preferably a C₆-C₈ group (such as cyclohexenyl); aralkyl denotes, for example, benzyl; alkaryl denotes, for example, tolyl or xylyl. More generally, alkaryl and aralkyl denote groups in which the aryl and alkyl moieties are as defined above.

Advantageously the substituents V¹, V², V³, V⁴, and V⁵ are identical to one another.

With preference the constituent (A) is an unfunctionalized linear polydimethylsiloxane, in other words containing repeating units of formula (CH₃)₂SiO_{2/2} and having (CH₃)₃SiO_{1/2} units at its two ends.

Constituent (A) is generally introduced into the composition in a proportion of 1 to 50 parts by weight per 100 parts by weight of the mixture of constituents (A), (B), (C), (D), (E), (F), (G), (H), (I), (J), and (K), preferably in a proportion of 3 to 40 parts, more preferably in a proportion of 3 to 30 parts, by weight.

Constituent (B) is a reactive linear polydiorganosiloxane oil having at least two OH groups per molecule and exhibiting a dynamic viscosity at 25° C. of in general between 50 and 50×10⁶ mPa·s.

In the context of the invention, the term “reactive” denotes the reactivity of constituent (B) to the crosslinking agents (D) and/or (E) that are present in the composition.

Preferably component (B) reacts with the crosslinking agent under the conditions in which the emulsion is prepared.

As a preferred constituent, the reactive polyorgano-siloxane (B) comprises the following siloxy units:

M=[(OH)(R²)₂SiO_{1/2}] and D=[R³R⁴SiO₂₁₂],

and in these formulae:
R², R³, and R⁴ are identical or different radicals selected from the group consisting of C₁-C₆ linear or branched alkyl radicals (such as, for example, methyl, ethyl, propyl, isopropyl, butyl, isobutyl, tert-butyl, n-pentyl, n-hexyl), C₃-C₈ cycloalkyl radicals (such as, for example, cyclopentyl, cyclohexyl), C₆-C₁₀ aryl radicals (such as, for example, phenyl, naphthyl), and C₆-C₁₅ alkylarylene radicals (such as, for example, tolyl, xylyl).

The preferred constituents for the reactive polyorganosiloxane (B) include the linear polyorganosiloxanes of formula:

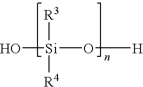

and in this formula n is an integer greater than or equal to 50, R³ and R⁴, which are identical or different, represent: a C₁-C₆ alkyl; a C₃-C₈ cycloalkyl; a C₂-C₈ alkenyl; a C₅-C₈ cycloalkenyl, an aryl, an alkylarylene, and an arylalkylene; each of the aforementioned radicals being optionally substituted by a halogen atom (and preferably fluorine) or a cyano residue.

The most commonly used oils, on account of their availability in industrial products, are those for which R³ and R⁴ are independently selected from the group of radicals consisting of: a methyl, an ethyl, a propyl, an isopropyl, a cyclohexyl, a vinyl, a phenyl, and a 3,3,3-trifluoropropyl. With great preference, at least approximately 80% by number of these radicals are methyl radicals.

In accordance with the invention, however, preference will be given to starting from polyorganosiloxane oils (B) which are already polymerized for the preparation of the emulsion, by using, for example, the techniques of emulsifying the silicone phase that are described in FR-A-2 697 021.

In one preferred embodiment of the invention the reactive polyorganosiloxane (B) is an α,ω-dihydroxypolydimethylsiloxane.

In the context of the present invention it is possible especially to use the α,ω-dihydroxypolydiorganosiloxanes prepared by the anionic polymerization process described in the U.S. Pat. Nos. 2,891,920 and especially 3,294,725 (which are cited as a reference).

Constituent (B), when present, is used in a proportion of 1% to 50% by weight, and preferably of 3% to 40% by weight, and more preferably in a proportion of 5% to 30% by weight, relative to the total weight of the composition.

Constituent (C) is a polyorganosiloxane resin which before emulsification carries condensable hydroxyl groups.

In the constituent units of these resins, each substituent R⁰ represents a monovalent organic group.

Generally speaking, R⁰ is a C₁-C₂₀ hydrocarbon radical which optionally carries one or more substituents.

Examples of hydrocarbon radicals are a linear or branched, saturated or unsaturated aliphatic group having preferably 1 to 10 carbon atoms; a saturated, unsaturated or aromatic, monocyclic or polycyclic carbocyclic group having preferably 3 to 18 carbon atoms, more preferably 5 to 10 carbon atoms; or a radical having an aliphatic moiety as defined above and a carbocyclic moiety as defined above.

The substituents of the hydrocarbon radical may be groups —OR′ or —O—CO—R′ in which R′ is a hydrogen atom or hydrocarbon radical as defined above which is not substituted.

The silicone resins (C) are well-known branched organopolysiloxane polymers whose preparation processes are described in numerous patents. Specific examples of resins that can be used include hydroxyl-containing or alkoxy-containing MQ, MDQ, DQ, DT, and MDT resins and mixtures thereof. In these resins each OH or alkoxy group is carried by a silicon atom belonging to a M, D or T unit.

With preference, examples of resins that can be used include hydroxyl-containing organopolysiloxane resins containing no unit Q in their structure. More preferably they include hydroxyl-containing DT and MDT resins containing at least 20% by weight of T units and having a weight content of hydroxyl or alkoxy group of from 0.1% to 10% and, more preferably, from 0.2% to 5%. In this group of more preferred resins, those suitable more particularly are those in which the average number of substituents R⁰ per silicon atom is between 1.2 and 1.8 per molecule. With even greater advantage, use is made of resins of this type in whose structure at least 80% by number of the substituents R⁰ are methyl radicals.

The resin (C) is liquid at ambient temperature. Preferably the resin exhibits a dynamic viscosity at 25° C. of between 0.2 and 200 Pa·s.

The resin is incorporated in the lubricating composition in a proportion of 0 to 50 parts by weight per hundred parts by weight of the sum of constituents (A), (B), (C), (D), (E), (F), (G), (H), (I), (J), and (K), preferably in a proportion of 0.1 to 30, more preferably 0.2 to 10, parts by weight.

The crosslinker (D) which is soluble in the silicone phase comprises at least two functions which are capable of reacting with the resin (C) in such a way as to bring about the crosslinking of said resin. Advantageously said reactive functions of the crosslinker (D) react with the resin (C) under the conditions in which the emulsion is prepared.

The crosslinker (D) preferably has the formula:

YₐSi(Zi)₄₋ₐ

in which:

a is 0, 1 or 2;

Y is a monovalent organic group; and

the groups Zi, which are identical or different, are selected from —OXₐ;

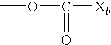

and —O—N═CH¹X², in which Xₐ, X_{b}, X¹, and X² are, independently, preferably C₁-C₂₀ (for example, C₁-C₁₀), saturated or unsaturated, linear or branched aliphatic hydrocarbon radicals, with the proviso that X¹ and X² may also represent a hydrogen atom and that Xₐ is a radical which is optionally substituted by (C₁-C₁₀) alkoxy.

In one preferred embodiment of the invention a represents 1, such that the formula of the crosslinker (D) is YSi(Zi)₃.

More preferably the groups Zi are identical to one another.

A preferred group of crosslinkers (D) is formed by the assembly of organotrialkoxysilanes, organotriacyloxysilanes, organotrioximosilanes, and tetraalkyl silicates.

More generally, with regard to symbol Y, the expression “monovalent organic group” embraces, in particular, C₁-C₃₀ linear or branched, saturated or unsaturated aliphatic radicals; C₆-C₃₀ saturated, unsaturated or aromatic, monocyclic or polycyclic carbocyclic radicals; and radicals having both an aliphatic moiety as defined above and a carbocyclic moiety as defined above, each of these radicals being optionally substituted by an amino, epoxy, thiol or ester function.

Examples of groups Y are, more particularly, (C₁-C₁₀) alkyl, (C₁-C₁₀)alkoxy or (C₂-C₁₀) alkenyl radicals which are optionally substituted by a group as follows:
epoxy;
thiol;
(C₃-C₈)cycloalkyl optionally substituted by epoxy;
(C₁-C₁₀)alkylcarbonyloxy optionally substituted by epoxy;
(C₂-C₁₀)alkenylcarbonyloxy optionally substituted by epoxy;
(C₃-C₈)cycloalkylcarbonyloxy optionally substituted by epoxy;
(C₆-C₁₀)arylcarbonyloxy;
—R^{a}—N(R¹) (R²) are as defined above;
—R^{b}—NH—R^{c}—NR¹R² in which R^{a}, R^{b}, R¹ and R² are as defined above;

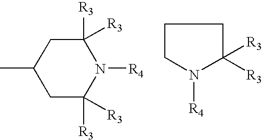

where R^{a}, R^{b}, and R¹ and R², R³, and R⁴ represent preferably C₁-C₃₀ linear or branched alkyl or aryl groups.

Preferably R³ represents a methyl, phenyl or benzyl group and R⁴ represents a hydrogen atom or a methyl group.

More preferably still, Y is an unsubstituted C₂-C₁₀ alkenyl; or else a C₁-C₁₀ alkyl optionally substituted by a group selected from:
thiol;
(C₁-C₁₀)alkylcarbonyloxy optionally substituted by epoxy;
(C₃-C₈)cycloalkyl optionally substituted by epoxy;
(C₂-C₁₀)alkenylcarbonyloxy; and
—R^{a}—N(R¹)(R²) where R^{a} represents a C₁-C₆ alkylene and R¹ and R² represent, independently, a hydrogen atom, a C₃-C₈ cycloalkyl or a C₆-C₁₀ aryl and more particularly a phenyl.

By way of example, Y represents an aminopropyl, ethylaminopropyl, n-butylaminoethyl, cyclohexylaminopropyl, phenylaminoethyl, N-aminoethylaminopropyl, dimethylaminopropyl, glycidyloxypropyl, 3,4-epoxycyclohexylethyl, mercaptopropyl, methacryloylxypropyl, methyl, ethyl or vinyl group.

The groups Zi are advantageously selected from C₁-C₁₀ alkoxy groups, C₁-C₁₀ alkylcarbonyloxy groups; or an oxime group —O—N═CX³X⁴ in which X³ and X⁴ are, independently, a hydrogen atom or a C₁-C₁₀ alkyl.

Preferably Zi represents a methoxy, ethoxy, propoxy, methoxyethoxy or acetoxy group or an oxime group.

One particularly preferred group of constituents (D) is formed by the alkyltrialkoxysilanes of formula YSi(Zi)₃ in which Y is an alkyl group, more particularly C₁-C₃₀, preferably C₁-C₁₀, alkyl and Zi is an alkoxy, more particularly C₁-C₂₀ and preferably C₁-C₁₀ alkoxy.

Among these mention may be made of methyltrimethoxysilane and methyltriethoxysilane.

Other appropriate crosslinkers (D) are described in U.S. Pat. No. 4,889,770, such as:
beta-aminoethyltrimethoxysilane,
beta-aminoethyltriethoxysilane,
beta-aminoethyltriisopropoxysilane,
gamma-aminopropyltrimethoxysilane,
gamma-aminopropyltriethoxysilane,
gamma-aminopropyltri(n-propoxy)silane,
gamma-aminopropyl(n-butoxy)silane,
delta-aminobutyltrimethoxysilane,
epsilon-aminohexyltriethoxysilane,
4-aminocyclohexyltriethoxysilane,
4-aminophenyltrimethoxysilane,
N-aminoethyl-gamma-aminopropyltrimethoxysilane,
N-aminoethyl-gamma-aminopropyltriethoxysilane,
beta-glycidyloxyethyltrimethoxysilane,
N-aminoethyl-N-aminoethyl-gamma-aminopropyltrimethoxysilane (or DYNASILANE TRIAMO)
beta-glycidyloxyethyltriethoxysilane,
gamma-glycidyloxypropyltriethoxysilane,
beta-(3,4-epoxycyclohexyl)ethyltrimethoxysilane,
beta-(3,3-epoxycyclohexyl)ethyltriethoxysilane,
gamma-(3,4-epoxycyclohexyl)propyltriethoxysilane,
gamma-mercaptopropyltrimethoxysilane,
gamma-mercaptopropyltriethoxysilane,
gamma-methacryloyloxypropyltrimethoxysilane,
gamma-methacryloyloxypropyltriethoxysilane,
methyltrimethoxysilane,
ethyltriethoxysilane,
vinyltrimethoxysilane,
allyltrimethoxysilane, and
   the corresponding compounds in which the alkoxy groups have been replaced by oximes or alkylcarbonyloxy groups.

The crosslinker (D) is incorporated in the lubricating composition in a proportion of 0.01 to 30 parts by weight per hundred parts by weight of the sum of constituents (A), (B), (C), (D), (E), (F), (G), (H), (I), (J), and (K), and preferably in a proportion of 0.01 to 20, more preferably 0.01 to 10, parts by weight.

An example of a water-soluble crosslinking agent (E) is 3-aminopropyltrihydroxysilane or the compound Silquest® VS142 sold by WITCO-OSI, in aqueous solution, which is composed of an oligomer of the silane described below, partially condensed by its SiOH functions:

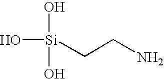

For the purposes of the present invention, water-solubility should be understood as the capacity of a product to dissolve in water at a temperature of 25° C., to an extent of at least 5% by weight.

This constituent (E) is used in a proportion of 0.01 to 50 parts by weight per hundred parts by weight of the sum of constituents (A), (B), (C), (D), (E), (F), (G), (H), (I), (J), and (K), preferably in a proportion of 0.1 to 20 parts by weight, and more preferably in a proportion of 0.1 to 10 parts by weight.

The nature of surfactant (F) will be readily determined by the person skilled in the art, the objective being to prepare a stable emulsion.

Anionic, cationic, nonionic and zwitterionic surfactants may be employed, alone or in a mixture.

Anionic surfactants include the alkali metal salts of aromatic sulfonic hydrocarbon acids or the alkali metal salts of alkylsulfuric acids.

Nonionic surfactants are preferred more particularly in the context of the invention. They include poly-(alkylene oxide) aryl or alkyl ethers, polyethoxylated sorbitan stearate, polyethoxylated sorbitan oleate having a saponification index of 102 to 108 and a hydroxyl index of 25 to 35, and cetylstearyl and poly(ethylene oxide) ethers.

Poly(alkylene oxide) aryl ethers include poly-ethoxylated alkylphenols. Poly(alkylene oxide) alkyl ethers include polyethylene glycol isodecyl ether and polyethylene glycol trimethylnonyl ether containing 3 to 15 units of ethylene oxide per molecule.

The amount of surfactant (F) is dependent on the type of each of the constituents present and also on the initial nature of the surfactant used. As a general rule, the composition contains from 0.1% to 10% by weight of surfactant per 100 parts by weight of the sum of constituents (A), (B), (C), (D), (E), (F), (G), (H), (I), (J), and (K), more preferably from 0.1% to 5% by weight.

Examples of film-forming polymers (G) are organic polymer latices, for example, styrene-acrylic copolymers or commercially available latices such as, for example, the styrene/alkyl acrylate or styrene/alkyl acrylate/acrylic acid copolymers of the RHODOPAS® range (for example, RHODOPAS® DS910, RHODOPAS® DS2800, RHODOPAS® DS1003, RHODOPAS® DS2818, RHODOPAS® DS2810 sold by RHODIA), the styrene/alkyl acrylate latices of the LIPATON® range, sold by POLYMER LATEX, and the styrene/alkyl acrylate or styrene/alkyl acrylate/acrylic acid copolymers of the UCAR® Latex range, sold by DOW CHEMICAL, Acronal® S400ap, sold by BASF, and Primal® 325 GB, sold by Rohm & Haas.

Advantageously the film-forming polymer (G) is selected from the styrene/alkyl acrylate or styrene/alkyl acrylate/acrylic acid copolymers of the RHODOPAS® range.

According to a first preferred embodiment the film-forming polymer (G) originates from the polymerization of:
at least one alkyl (meth)acrylate monomer selected from the group consisting of methyl (meth)acrylate, ethyl or hydroxyethyl (meth)acrylate, propyl or hydroxypropyl (meth)acrylate, butyl or hydroxybutyl (meth)acrylate, and 2-ethylhexyl (meth)acrylate,
a styrene monomer, and
optionally at least one monomer selected from the group consisting of acrylic acid and methacrylic acid.

According to a second embodiment the film-forming polymer (G) originates from the polymerization of:
at least one alkyl (meth)acrylate monomer selected from the group consisting of methyl (meth)acrylate, ethyl (meth)acrylate, propyl (meth)acrylate, and butyl (meth)acrylate,
a styrene monomer, and
optionally at least one monomer selected from the group consisting of acrylic acid, methacrylic acid, maleic acid, fumaric acid, and itaconic acid.

According to a third embodiment the film-forming polymer (G) is selected from styrene/butyl acrylate/acrylic acid copolymers with the following weight ratios relative to the total weight of the copolymer:
styrene monomer: between 25% and 55% by weight,
butyl acrylate monomer: between 74.5% and 40% by weight, and
acrylic acid monomer: between 0.5% and 5% by weight.

The film-forming polymer (G) is incorporated in the lubricating composition in a proportion of 0.1 to 50 parts by weight (dry) per hundred parts by weight of the sum of constituents (A), (B), (C), (D), (E), (F), (G), (H), (I), (J), and (K), and preferably in a proportion of 1 to 45, more preferably 5 to 40, parts by weight.

The lubricating composition according to the present invention may optionally comprise one or more additional ingredients such as thickeners (H), wetting agents (I), and additives (J) that are well known to a person skilled in the art.

Examples of thickeners (H) include the following: cellulosic thickeners (carboxymethylcellulose), acrylic thickeners, polyurethane thickeners, hydrocolloid gums (xanthan gum), and mixtures thereof.

Examples of wetting agents (I) include the following: phosphates and/or polyacrylics, such as, for example, sodium hexametaphosphate and sodium polyacrylates.

Examples of additives (J) include the following: complementary lubricants and antifriction agents, coalescence agents, dispersants, air evacuation agents, antifoam agents, stabilizers, preservatives such as biocides, and antifungals, in amounts which can vary considerably, for example, between 0.2% and 50% by weight, relative to the total weight of the composition.

As a coalescence agent it is possible to use glycols and/or aliphatic petroleum cuts (petroleum distillation fractions).

The compositions of the invention may be prepared conventionally by employing conventional methods of the state of the art.

The emulsification may be direct or by inversion.

For direct emulsification, the process involves emulsifying a mixture of the constituents (a), (b), (c), (d), and (f) in an aqueous phase containing the surfactant. An oil-in-water emulsion is obtained directly. The remaining constituents may then be added, either directly to the emulsion (in the case of water-soluble constituents) or subsequently in emulsion form (in the case of constituents which are soluble in the silicone phase).

The particle size of the emulsion obtained above may be adjusted by the conventional methods known to a person skilled in the art, more particularly by continuing stirring within the reactor for an appropriate time.

Ordinarily, the methods of the invention are employed at ambient temperature. It is preferred to limit the temperature rise that may result from the steps of grinding or of stirring. In particular a choice is made to remain below 60 or 65° C.

The constituents (A) to (K) are available commercially or are readily obtainable for a person skilled in the art through the implementation of conventional processes described in the prior art.

The present invention also provides articles lubricated using the lubricating composition of the invention, and the use of the lubricating composition of the invention for the lubrication of various articles.

The invention relates more particularly to the following:
an expandable rubber bladder coated on its external surface with a composition according to the invention, for shaping and curing pneumatic or semipneumatic tires;
an expandable rubber bladder coated with lubricant and obtainable after drying at ambient temperature or by heating of the expandable vessel defined above, in particular at 80-150° C. (preferably 100-150° C.), so as to ensure the complete crosslinking of the crosslinkable constituents of the emulsion. The crosslinking of the lubricating film by heating may be carried out in an oven or directly in the tire manufacturing press during the preheating of the bladder;
a pneumatic or semipneumatic green tire comprising elements which will constitute its outer tread intended to come into contact with the ground, coated on its inner surface with a composition according to the invention; and
the use of a lubricating composition according to the invention in the shaping and curing of pneumatic or semipneumatic tires, for the lubrication of the expandable rubber curing bladder or of the pneumatic or semipneumatic green tire prior to its curing.

The lubricating composition of the invention may be applied in any manner, and, for example, by spraying, by brushing or else using a sponge, a piece of cloth or a fine brush. It is preferable to operate in such a way as to cover the article to be coated with a uniform layer of coating.

The lubricating composition is applied alternatively to the bladder, to the inner surface of the unvulcanized tire (the inner liner) or to both. This combination allows the unvulcanized tire to slide on the bladder when the press closes, while providing assurance of an effective course of the demolding step of the vulcanized (cured) tire. This makes it possible to prevent the cured tire adhering to the bladder. Accordingly, the number of demoldings possible by application of demolding agent, and also the number of demoldings possible per bladder, is increased with no loss of quality in the cured tire, particularly as regards the symmetry of the resulting tires.

The lubricating composition of the invention also exhibits excellent sliding properties and durability properties.

The examples which follow, and which illustrate the invention, attest to the excellent lubricating properties of the compositions of the invention.

### EXAMPLE 1

An emulsion A (Invention) is prepared whose nature and the proportions of these constituents are given respectively in table 1 below:

TABLE 1
Emulsion A (Invention)

| | | Parts by |
|---|---|---|
| Nature of the constituent | Identification | weight |
| Linear, (CH₃)₃SiO_{1/2}-terminal | Constituent (A) | 8.8% |
| polydimethylsiloxane with a | | |
| dynamic viscosity equal to a | | |
| viscosity of 1000 mPa · s at 25° C. | | |
| α,ω-Dihydroxy poly(dimethyl)- | Constituent (B) | 11.7% |
| siloxane silicone oil, | | |
| viscosity = 135 000 mPa · s at | | |
| 25° C. | | |
| Silicone resin containing MDT | Constituent (C) | 0.8% |
| units and 0.5% by weight of OH | | |
| groups (dynamic viscosity at | | |
| 25° C. = 1 Pa · s)⁽¹⁾ | | |
| Methyltriethoxysilane | Constituent (D) | 0.07% |
| Surfactant, Rhodasurf ® ROX | Constituent (F) | 1.25% |
| Thickener, Rheozan ® | Constituent (H) | 0.17% |
| Styrene/butyl acrylate/ | Constituent (G) | 18% |
| acrylic acid latex in emulsion | | |
| form (Rhodopas ® DS 2800, sold by | | |
| Rhodia) | | |
| Wetting agent, Trycol ® 5950 | Constituent (I) | 0.5% |
| Wetting agent, Geropon ® DOS/PG | Constituent (I) | 0.4% |
| 23% aqueous solution of | Constituent (E) | 0.5% |
| NH₂—(CH₃)₃—Si(OH)₃ | | |
| Antifoam agent | Constituent (J) | 0.14% |
| Biocide | Constituent (J) | 0.02% |
| Antioxidant | Constituent (J) | 0.04% |
| Distilled water | Constituent (K) | 57.61% |

⁽¹⁾MDT resin having a hydroxylation rate of 0.5% by weight, an average number of organic radicals of 1.5 per silicon atom per molecule, a dynamic viscosity at 25° C. of 0.1 Pa · s, and the following proportions of siloxy units:
M: 17 mol %
D: 26 mol %
T: 57 mol %.

The % indicated below are by weight relative to the total weight of the composition.

### Preparation of an Inventive Composition A:

The lubricating composition of table 1 was prepared as indicated below.

In an IKA® reactor equipped with an anchor blade, a mixture composed of the nonreactive polydimethyl-siloxane (A), the reactive oil (B), the resin (C), the methyltriethoxysilane (D), the surfactant (F), and a portion of distilled water (in a water/surfactant ratio of 0.9) is homogenized.

Phase inversion is observed. The system changes from a water/oil phase to a thick oil/water phase.

The thick phase obtained is diluted with moderate stirring, using the remaining amount of distilled water. The other constituents are added at the end of dilution, and the product is homogenized with moderate stirring.

The resulting emulsion is characterized by an average particle size of 0.500 μm, a Brookfield viscosity of 180 cps (A3V100), and a solids content (60 min, 120° C.) of 34.0% by weight.

### EXAMPLE 2

### Invention

An emulsion B (invention) is prepared by the same procedure as that of example 1. The nature and the proportions of these constituents are given respectively in table 2 below:

TABLE 2
Emulsion B (Invention)

| | | Parts by |
|---|---|---|
| Nature of the constituent | Identification | weight |
| Linear, (CH₃)₃SiO_{1/2}-terminal | Constituent (A) | 10.9% |
| polydimethylsiloxane with a | | |
| dynamic viscosity equal to a | | |
| viscosity of 1000 mPa · s at 25° C. | | |
| α,ω-Dihydroxy poly(dimethyl)- | Constituent (B) | 14.67% |
| siloxane silicone oil, | | |
| viscosity = 135 000 mPa · s at | | |
| 25° C. | | |
| Silicone resin containing MDT | Constituent (C) | 0.99% |
| units and 0.5% by weight of OH | | |
| groups (dynamic viscosity at | | |
| 25° C. = 1 Pa · s)⁽¹⁾ | | |
| Methyltriethoxysilane | Constituent (D) | 0.09% |
| Surfactant, Rhodasurf ® ROX | Constituent (F) | 1.57% |
| Thickener, Rheozan ® | Constituent (H) | 0.21% |
| Styrene/butyl acrylate/ | Constituent (G) | 10% |
| acrylic acid latex in emulsion | | |
| form (Rhodopas ® DS 2800, sold by | | |
| Rhodia) | | |
| Wetting agent, Trycol ® 5950 | Constituent (I) | 0.6% |
| Wetting agent, Geropon ® DOS/PG | Constituent (I) | 0.4% |
| 23% aqueous solution of | Constituent (E) | 0.6% |
| NH₂—(CH₃)₃—Si(OH)₃ | | |
| Antifoam agent | Constituent (J) | 0.18% |
| Biocide | Constituent (J) | 0.018% |
| Antioxidant | Constituent (J) | 0.045% |
| Distilled water | Constituent (K) | 59.727% |

⁽¹⁾MDT resin having a hydroxylation rate of 0.5% by weight, an average number of organic radicals of 1.5 per silicon atom per molecule, a dynamic viscosity at 25° C. of 0.1 Pa · s, and the following proportions of siloxy units:
M: 17 mol %
D: 26 mol %
T: 57 mol %.

The resulting emulsion is characterized by an average particle size of 0.510 μm, a Brookfield viscosity of 271 cps (A3V100), and a solids content (60 min, 120° C.) of 31.0% by weight.

### EXAMPLE 3

### Comparative

An emulsion C (comparative) is prepared by the same procedure as that of example 1. The nature and the proportions of these constituents are given respectively in table 3 below:

TABLE 3
Emulsion C (Comparative)

| | | Parts by |
|---|---|---|
| Nature of the constituent | Identification | weight |
| Linear, (CH₃)₃SiO_{1/2}-terminal | Constituent (A) | 12.12% |
| polydimethylsiloxane with a | | |
| dynamic viscosity equal to a | | |
| viscosity of 1000 mPa · s at 25° C. | | |
| α,ω-Dihydroxy poly(dimethyl)- | Constituent (B) | 15.27% |
| siloxane silicone oil, | | |
| viscosity = 135 000 mPa · s at | | |
| 25° C. | | |
| Silicone resin containing MDT | Constituent (C) | 2.03% |
| units and 0.5% by weight of OH | | |
| groups (dynamic viscosity at | | |
| 25° C. = 1 Pa · s)⁽¹⁾ | | |
| Methyltriethoxysilane | Constituent (D) | 0.19% |
| Surfactant, Rhodasurf ® ROX | Constituent (F) | 1.73% |
| Thickener, Rheozan ® | Constituent (H) | 0.23% |
| Wetting agent, Trycol ® 5950 | Constituent (I) | 0.69% |
| Wetting agent, Geropon ® DOS/PG | Constituent (I) | 0.45% |
| 23% aqueous solution of | Constituent (E) | 0.94% |
| NH₂—(CH₃)₃—Si(OH)₃ | | |
| Antifoam agent | Constituent (J) | 0.2% |
| Biocide | Constituent (J) | 0.02% |
| Antioxidant | Constituent (J) | 0.05% |
| Distilled water | Constituent (K) | 66.11% |

⁽¹⁾MDT resin having a hydroxylation rate of 0.5% by weight, an average number of organic radicals of 1.5 per silicon atom per molecule, a dynamic viscosity at 25° C. of 0.1 Pa · s, and the following proportions of siloxy units:
M: 17 mol %
D: 26 mol %
T: 57 mol %.

The resulting emulsion is characterized by an average particle size of 0.300 μm, a Brookfield viscosity of 342 cps (A3V100), and a solids content (60 min, 120° C.) of 29.1% by weight.

### EXAMPLE 4

### Comparative

An emulsion D (comparative) is prepared by the same procedure as that of example 1. The nature and the proportions of these constituents are given respectively in table 4 below:

TABLE 4
Emulsion D (Comparative)

| | | Parts by |
|---|---|---|
| Nature of the constituent | Identification | weight |
| Linear, (CH₃)₃SiO_{1/2}-terminal | Constituent (A) | 12.16% |
| polydimethylsiloxane with a | | |
| dynamic viscosity equal to a | | |
| viscosity of 1000 mPa · s at 25° C. | | |
| α,ω-Dihydroxy poly(dimethyl)- | Constituent (B) | 16.29% |
| siloxane silicone oil, | | |
| viscosity = 135 000 mPa · s at | | |
| 25° C. | | |
| Silicone resin containing MDT | Constituent (C) | 1.09% |
| units and 0.5% by weight of OH | | |
| groups (dynamic viscosity at | | |
| 25° C. = 1 Pa · s)⁽¹⁾ | | |
| Methyltriethoxysilane | Constituent (D) | 0.1% |
| Surfactant, Rhodasurf ® ROX | Constituent (F) | 1.74% |
| Thickener, Rheozan ® | Constituent (H) | 0.23% |
| DYNASILANE MEMO | Constituent (D) | 1.33% |
| Wetting agent, Trycol ® 5950 | Constituent (I) | 0.69% |
| Wetting agent, Geropon ® DOS/PG | Constituent (I) | 0.45% |
| 23% aqueous solution of | Constituent (E) | 3.35% |
| NH₂—(CH₃)₃—Si(OH)₃ | | |
| Antifoam agent | Constituent (J) | 0.2% |
| Biocide | Constituent (J) | 0.02% |
| Antioxidant | Constituent (J) | 0.05% |
| Distilled water | Constituent (K) | 62.30% |

⁽¹⁾MDT resin having a hydroxylation rate of 0.5% by weight, an average number of organic radicals of 1.5 per silicon atom per molecule, a dynamic viscosity at 25° C. of 0.1 Pa · s, and the following proportions of siloxy units:
M: 17 mol %
D: 26 mol %
T: 57 mol %.

The resulting emulsion is characterized by an average particle size of 0.550 μm, a Brookfield viscosity of 358 cps (A3V100), and a solids content (60 min, 120° C.) of 32.0% by weight.

### EXAMPLE 5

### Comparative

An emulsion E (comparative) is prepared by the same procedure as that of example 1. The nature and the proportions of these constituents are given respectively in table 5 below:

TABLE 5
Emulsion E (Comparative)

| | | Parts by |
|---|---|---|
| Nature of the constituent | Identification | weight |
| Linear, (CH₃)₃SiO_{1/2}-terminal | Constituent (A) | 10.1% |
| polydimethylsiloxane with a | | |
| dynamic viscosity equal to a | | |
| viscosity of 1000 mPa · s at 25° C. | | |
| α,ω-Dihydroxy poly(dimethyl)- | Constituent (B) | 12.73% |
| siloxane silicone oil, | | |
| viscosity = 135 000 mPa · s at | | |
| 25° C. | | |
| Silicone resin containing MDT | Constituent (C) | 1.69% |
| units and 0.5% by weight of OH | | |
| groups (dynamic viscosity at | | |
| 25° C. = 1 Pa · s)⁽¹⁾ | | |
| Methyltriethoxysilane | Constituent (D) | 0.16% |
| Surfactant, Rhodasurf ® ROX | Constituent (F) | 1.44% |
| Thickener, Rheozan ® | Constituent (H) | 0.19% |
| Wetting agent, Trycol ® 5950 | Constituent (I) | 0.58% |
| Wetting agent, Geropon ® DOS/PG | Constituent (I) | 0.45% |
| 23% aqueous solution of | Constituent (E) | 0.78% |
| NH₂—(CH₃)₃—Si(OH)₃ | | |
| Antifoam agent | Constituent (J) | 0.17% |
| Biocide | Constituent (J) | 0.02% |
| Antioxidant | Constituent (J) | 0.04% |
| Distilled water | Constituent (K) | 71.65% |

⁽¹⁾MDT resin having a hydroxylation rate of 0.5% by weight, an average number of organic radicals of 1.5 per silicon atom per molecule, a dynamic viscosity at 25° C. of 0.1 Pa · s, and the following proportions of siloxy units:
M: 17 mol %
D: 26 mol %
T: 57 mol %.

The resulting emulsion is characterized by an average particle size of 0.500 μm, a Brookfield viscosity of 175 cps (A3V100), and a solids content (60 min, 120° C.) of 24.3% by weight.

### Applications Properties

The properties of the compositions are measured by evaluating the friction coefficients and the durability.

A low friction coefficient reflects good sliding properties.

The tests measuring the friction coefficients and the durability were adapted to the application of the lubricating composition to an expandable rubber bladder.

### Sliding Test

The objective of this test is to assess the sliding power of a lubricating composition placed at the interface between the inflatable bladder and the inner surface of the envelope of a pneumatic tire.

This test is carried out by sliding a metal block of predetermined weight, under which a pneumatic tire envelope film (50×75 mm) is fixed, over a rubber surface whose composition is that of the inflatable bladder.

The surface of the inflatable bladder is pretreated with the lubricating composition in accordance with a procedure very similar to that used in production.

The friction coefficient is measured using a tensiometer (at a speed of 50 mm/min.). Five successive passes are made on the same inflatable bladder sample, the pneumatic tire envelope sample being changed each time.

The lower the values of the friction coefficient, the better the sliding properties of the lubricating composition.

The five passes provide information on the depletion of the lubricating composition in the course of successive moldings.

This sliding test is a very good representation of the performance achieved on industrial tooling, and is a first selection criterion.

### Durability Test

The durability of a lubricating composition corresponds to the number of tires produced without damage to the surface of the inflatable bladder. An inflatable bladder film pretreated with the lubricating composition under evaluation is pressed into contact with a tire envelope film, uncured, in a series of pressure and temperature cycles which simulate the steps of manufacturing a tire on industrial tooling.

The tire envelope film is replaced for each molding. The test is terminated when the two surfaces in contact remain stuck. The lubricating composition at the surface of the film of the inflatable bladder is depleted and no longer acts as a lubricating interface.

### Transfer Durability Test

The durability of a lubricating composition corresponds to the number of tires produced without damage to the surface of the inflatable bladder. An inflatable bladder film is pressed into contact with a tire envelope film, uncured, in a series of pressure and temperature cycles which simulate the steps of manufacturing a tire on industrial tooling.

The first tire envelope film molded is pretreated with the lubricating composition under evaluation, to simulate the transfer of the lubricant of the tire envelope to the bladder. Thereafter, the tire envelope film is replaced in each molding by an untreated film. The test is terminated when the two surfaces in contact remain stuck. The lubricating composition at the surface of the film of the inflatable bladder is depleted and no longer acts as a lubricating interface.

The results of the tests are set out in table 5.

TABLE 5

| | | | | Durability |
|---|---|---|---|---|
| | | | Durability | in transfer |
| | | | in direct | from the |
| | Viscosity | Lubrication | application | envelope to |
| Examples | A3V100 mPas | (average kd) | to bladder | the bladder |
| Example 1 | 180 | 0.40 | 6 | 5 |
| Example 2 | 271 | 0.38 | 9 | 7 |
| Comparative | 342 | 0.32 | 28 | 3 |
| example 3 | | | | |
| Comparative | 358 | 0.30 | 3 | 3 |
| example 4 | | | | |
| Comparative | 175 | 0.30 | 1 | 0 |
| example 5 | | | | |

It is apparent that it is very difficult to obtain a composition which allows the following two properties to be obtained simultaneously:
high durability in direct application to a bladder (useful for the manufacture of heavy-vehicle tires, an operation characterized by ease of access to the bladder),
high durability in transfer of the envelope to a bladder (useful for the manufacture of lightweight-vehicle tires, an operation characterized by difficulty of access to the bladder, which is the reason for treatment of the green tire and then transferred to the bladder), and
good sliding properties (Kd less than 0.45).

The compositions according to the invention allow the three properties to be obtained, which means that they can be used in the manufacture of light or heavy duty tires.

1.-18. (canceled)

19. A siloxane-based lubricating composition, formulated as an oil-in-water emulsion, which does not release hydrogen, comprising:
(a) at least one non-reactive polydiorganosiloxane oil (A) having lubricating properties, having a dynamic viscosity on the order of 20 to 100,000 mPa·s at 25° C.;
(b) at least one reactive linear polydiorganosiloxane oil (B) having per molecule at least two OH groups, said polydiorganosiloxane having a dynamic viscosity at 25° C. ranging from 50 to 50×10⁶ mPa·s,
(c) optionally, at least one polyorganosiloxane resin (C) which before emulsification carries condensable hydroxyl substituents and also which before emulsification contains at least two different siloxy units selected from among those of formulae)(R⁰)₃SiO_{1/2} (M); (R⁰)₂SiO_{2/2}(D); R⁰SiO_{3/2} (T), and SiO_{4/2} (Q), at least one of these units being a T or Q unit, R⁰ in the formulae representing a monovalent organic substituent, the average number of organic radicals R⁰ per molecule for one silicon atom being 1 or 2; and said resin having a weight content of hydroxyl or alkoxy substituents ranging from 0.1% to 10% by weight,
(d) at least one crosslinking agent (D) which is soluble in the silicone phase,
(e) at least one water-soluble crosslinking agent (E), whose formula, in its monomeric form, is:
(R²)(R¹)N—R^{a}—Si(OH)₃
in which R^{a} is a C₁-C₂₀ alkylene radical, and R¹ and R² are independently a hydrogen atom or a C₁-C₆ alkyl radical, such crosslinking agent being capable of oligomerization by condensation of one or more silanol functions,
(f) at least one surfactant (F),
(g) water (K),
(h) at least one film-forming polymer (G),
(i) optionally, at least one thickener (H),
(j) optionally, at least one wetting agent (I), and
(k) optionally, at least one additive (J), with the proviso that:
(1) the amounts of surfactant(s) and water are sufficient to provide an oil-in-water emulsion, and
(2) said lubricating composition contains no metallic condensation catalyst.

20. The lubricating composition as defined by claim 19, wherein said at least one film-forming polymer (G) comprises an organic polymer latex.

21. The lubricating composition as defined by claim 19, wherein said at least one film-forming polymer (G) is prepared by polymerization of:
at least one alkyl (meth)acrylate monomer selected from the group consisting of methyl (meth)acrylate, ethyl (meth)acrylate, propyl (meth)acrylate, and butyl (meth)acrylate,
a styrene monomer, and
optionally, at least one monomer selected from the group consisting of acrylic acid, methacrylic acid, maleic acid, fumaric acid, and itaconic acid.

22. The lubricating composition as defined by claim 19, wherein said at least one crosslinking agent (D) is soluble in said silicone phase and is selected from among the organotrialkoxysilanes, organotriacyloxysilanes, organotrioximosilanes, and tetraalkyl silicates.

23. The lubricating composition as defined by claim 22, wherein said at least one crosslinking agent (D) which is soluble in the silicone phase comprises an alkyltrialkoxysilane of formula YSiZ₃ in which Y is an alkyl radical and Z is an alkoxy radical.

24. The lubricating composition as defined by claim 19, wherein said at least one non-reactive polydiorganosiloxane oil (A) comprises a linear polydiorganosiloxane having repeating units of formula (R)₂SiO_{2/2}, which is terminated at its chain ends by units (R)₃SiO_{1/2}, in which R is a monovalent organic radical selected from the group consisting of alkyl, alkenyl, aryl, cycloalkyl, cycloalkenyl, aralkyl, and alkaryl radicals.

25. The lubricating composition as defined by claim 24, wherein said at least one non-reactive polydiorganosiloxane oil (A) comprises a polydimethylsiloxane.

26. The lubricating composition as defined by claim 19, comprising at least one polyorganosiloxane resin (C) which is a hydroxyl-containing MDT or DT resin containing at least 20% by weight of T units and having a weight content of hydroxyl groups ranging from 0.1% to 10%.

27. The lubricating composition as defined by claim 26, wherein said at least one polyorganosiloxane resin (C) has a dynamic viscosity at 25° C. ranging from 0.2 and 200,000 mPa·s.

28. The lubricating composition as defined by claim 19, wherein the formula of said at least one reactive linear polydiorganosiloxane oil (B) is: 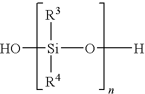
wherein n is an integer greater than or equal to 50, R³ and R⁴, which may be identical or different, are each a C₁-C₆ alkyl; a C₃-C₈ cycloalkyl; a C₂-C₈ alkenyl; a C₅-C₈ cycloalkenyl, an aryl, an alkylarylene, or an arylalkylene radical, each of the aforementioned radicals being optionally substituted by a halogen atom or a cyano residue.

29. The lubricating composition as defined by claim 19, comprising from 0.5% to 10% by weight of surfactant, relative to the total weight thereof.

30. A green pneumatic or semi-pneumatic tire comprising an outer tread suited to contact the ground and coated on its inner surface with a lubricating composition as defined by claim 19.

31. An expandable rubber bladder coated on its external surface with a lubricating composition as defined by claim 19, useful for shaping and curing pneumatic or semi-pneumatic tires.

32. An expandable rubber bladder produced by drying at ambient temperature or by heating at a temperature of 80° C. to 150° C. of a bladder as defined by claim 31.

33. A shaped article coated with a lubricating composition as defined by claim 19.

34. A shaped article produced by heating an article as defined by claim 33.

35. A process for the shaping and curing of a pneumatic or semi-pneumatic tire, or for the lubrication of an expandable rubber curing bladder, comprising a step of lubrication with the lubricating composition as defined by claim 19.

36. The lubricating composition as defined by claim 20, said at least one film-forming polymer (G) comprising a styrene-acrylic copolymer.
